(19) United States
(12) Patent Application Publication
(10) Pub. No.: US 2020/0228772 A1
(43) Pub. Date: Jul. 16, 2020

(54) MEDIA PLAYER

(71) Applicant: Chi Kwan LAU, Saratoga, CA (US)

(72) Inventor: Chi Kwan LAU, Saratoga, CA (US)

(21) Appl. No.: 16/739,979

(22) Filed: Jan. 10, 2020

Related U.S. Application Data
(60) Provisional application No. 62/791,687, filed on Jan. 11, 2019.

(51) Int. Cl. H04N 9/87; G06Q 30/02; G11B 33/12

(52) U.S. Cl. CPC H04N 9/87; G11B 33/127; G06Q 30/0281

(57) ABSTRACT

A media player unit having a circuitry is disclosed herein. The media player unit comprises at least two dedicated memory sets, wherein one of the at least two dedicated memory set is fed with a first display content and another one of the at least two dedicated memory set is fed with a second display content. At least one switch is coupled to each of the dedicated memory sets for facilitating selective playing of the first display content or the second display content stored in any one of the at least two memory sets by the media player unit. In one embodiment, the switch is a single or double-pole-double-throw (SPDT or DPDT) toggle switch with a pull cord. In another embodiment, the switch is configured to be activated via a remote controller.

### CROSS-REFERENCE TO RELATED APPLICATIONS

The present Utility patent application claims priority benefit of the U.S. provisional application for patent Ser. No. 62/791,687 entitled “Open/Closed Signage Media Player”, filed on 11 Jan. 2019 under 35 U.S.C. 119(e). The contents of this related provisional application are incorporated herein by reference for all purposes to the extent that such subject matter is not inconsistent herewith or limiting hereof

### RELATED CO-PENDING U.S. PATENT APPLICATIONS

Not applicable.

### INCORPORATION BY REFERENCE OF SEQUENCE LISTING PROVIDED AS A TEXT FILE

Not applicable.

### FEDERALLY SPONSORED RESEARCH OR DEVELOPMENT

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to a media player. More particularly, certain embodiments of the invention relates to a media player for displaying content associated with open and closing hours of a business establishment.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Conventional Open/Closed signage is still in the pre-digital age, even though almost every business has a sign hanging at the front door or window displaying “Open” during business hours and displaying “Closed” when closed. Most of these signs are made of a plastic board with double-sided prints. One easy flip is all it takes for business to change from “Open” to “Closed”.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that some media players may be specifically designed for usage as an open/closed signage player for a business establishment. A typical media player may include a CPU, GPU, DRAM, SRAM or FLASH, and OS. In general, a media player requires a user to perform setup in order to play a media file. A setup may include the steps of turning on the media player; navigating to the desired file from a menu page of the GUI of the media player, selecting the files and providing the play command for displaying the desired file on a desired display, e.g., a computer monitor or a remotely located display screen. To use a media player for Open/Closed signage, a user has to perform such a setup every time before business open and do it again at closing.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a perspective view of a media player, in accordance with an embodiment of the present invention;

FIG. 2 is a detailed view of the two sets of dedicated memories built into one side of the media player, in accordance with an embodiment of the present invention;

FIG. 3 is a perspective view of media player, in accordance with another embodiment of the present invention;

FIG. 4 illustrates an example of using the invention as Open/Closed signage in a business establishment;

FIG. 5 illustrates a perspective view of a media player, in accordance with yet another embodiment of the present invention;

FIG. 6 illustrates a perspective view of a media player, in accordance with yet another embodiment of the present invention; and

FIG. 7 illustrates a perspective view of a media player, in accordance with yet another embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising” And “contain” and variations of them—Such terms are open-ended and mean “including but not limited to”. When employed in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

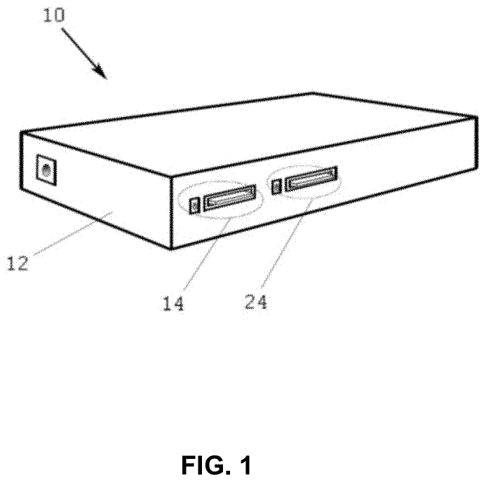

FIG. 1 is a perspective view of a media player, in accordance with an embodiment of the present invention. At least one embodiment of the present invention relates to a media player for interactive selection and display of digital content. A media player, as used herein, may include a digital media player, multimedia player, signage media player, video player, streaming player, set-top box, or TV player. The digital content may be displayed by the media player may be any type of digital content, e.g., signs, ads, videos, pictures, music, text, and the like. In one embodiment of the invention, a media player 10 as shown in FIG. 1, includes an exemplary media player unit 12 comprising two dedicated memory sets 14 and 24 configured on the media player unit 12.

In an embodiment, the media player unit 12 may be any media player. In an embodiment, the media player unit 12 may be configured to feature the auto-play functionality. Auto-play means a media player starts to play a default set of files when power is switched on. Different media players may have different names for this feature, and some players may have it installed as default without mentioning it. The auto-play capability may be created by a set of codes which is part of the firmware of the media player. An auto-play feature may be added to any media player by updating the firmware of the media player.

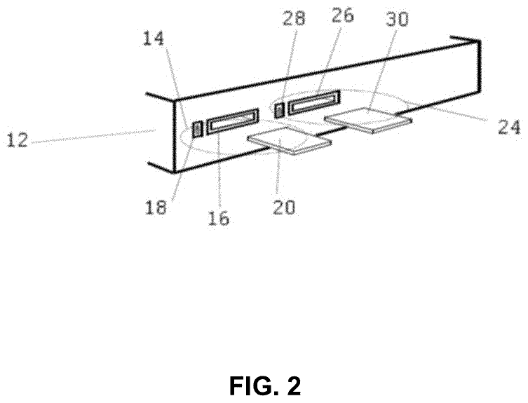

FIG. 2 is a detailed view of the two sets of dedicated memories built into one side of the media player, in accordance with an embodiment of the present invention. Referring to FIG. 2, a first dedicated memory set 14 may be configured into media player unit 12 and may include a memory media slot 16, an ON/OFF switch 18, and a removable memory media 20. Similarly, the second dedicated memory set 24 may be may be configured into the media player unit 12 and may include a memory media slot 26, an ON/OFF switch 28, and a removable memory media 30. Examples of removable memory media include without limitation Flash memory card such as SD card and USB flash memory such as USB stick.

In an embodiment, the memory media slots 16, 26 and the ON/OFF switches 18, 28 may be configured into a circuit board of the media player unit 12. More specifically, the ON/OFF switches 18, 28 may be located anywhere on the body of the media player unit 12. In another embodiment, the ON/OFF switches 18, 28 may be integrated to the memory media slots 16, 26. Furthermore, in another embodiment, the dedicated memory sets 14, 24 may include the usage of any form of removable memory apart from the usage of memory media 20, 30. In yet another embodiment, the dedicated memory sets 14, 24 may be housed in a separate enclosure in wired connection to media player unit 12.

In one embodiment, each of the dedicated memory sets 14, 24 may have their own respective ON/OFF switching mechanism, which may be implemented as, but not limited to, ON/OFF switch 18, 28 as shown in FIG. 2. When ON/OFF switch 18 is turned on, the corresponding memory media 20 inserted within the memory media slot 16 is electrically connected to media player unit 12; and media player 10, when powered on, plays the files stored in the memory media 20. When ON/OFF switch 18 is turned off, the corresponding memory media 20 inserted within the memory media slot 16 is electrically disconnected from media player unit 12. Similarly, when ON/OFF switch 28 is turned on, the corresponding memory media 30 inserted within the memory media slot 26 is electrically connected to media player unit 12; and media player 10, when powered on, plays the files in memory media 30. When ON/OFF switch 28 is turned off, corresponding memory media 30 inserted within the memory media slot 24 is electrically disconnected from media player 12.

A typical memory media may include power VDD, ground VSS, clock CLK, media enable/select CA/CS, and data in/out DI/DO or D+/D−, among other electrical paths. Similar electrical paths may exist in the corresponding circuitry inside the circuit board of the media player. Any of these paths may be manipulated, via hardware or software, by the ON/OFF switching mechanism to electrically connect or disconnect an inserted memory media to the media player. ON/OFF switches 18, 28, in accordance with an embodiment of the present invention, may be implemented to connect/disconnect one or more of these electrical paths.

An exemplary application of the media player 10 may be its use for displaying Open/Closed signage. More specifically, to use the media player 10 for Open/Closed signage, files for open business hours may be stored in one memory media 20 for example, inserted into one memory media slot 16, and files for closing may be stored in another memory media 30 inserted into another memory media slot 26. In accordance with one embodiment, an auto-play feature of the media player 10 may be activated for playing or displaying the open business hour files by switching on ON/OFF switch 18 and switching off ON/OFF switch 28. Similarly, when closing, switching off ON/OFF switch 18 and switching on ON/OFF switch 28 may facilitate playing or displaying the files for closing.

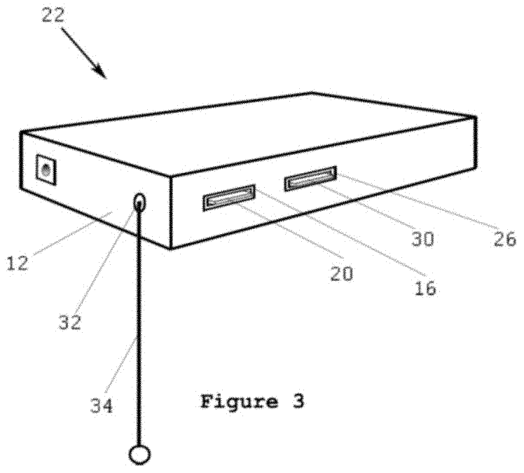

FIG. 3 is a perspective view of a media player 22, in accordance with another embodiment of the present invention. Referring to FIG. 3, in which the two ON/OFF switches 18 and 28 shown in FIG. 2 are replaced with a single or double-pole-double-throw (SPDT or DPDT) toggle switch 32 with a pull cord 34 attached thereto for facilitating switching. In an embodiment, the toggle switch 32 may connect either memory media 20 or memory media 30 to media player unit 12. More specifically, while the media player 22 is playing files in memory media 20, pulling on the cord 34 disconnects memory media 20 from and connects memory media 30 to media player unit 12 and media player 22 starts playing the files in memory media 30 instead. Pulling the cord 34 again switches back to play files in memory media 20. The toggle switch 32 may be located anywhere on the body of the media player unit 12 to facilitate easy pull cord switching.

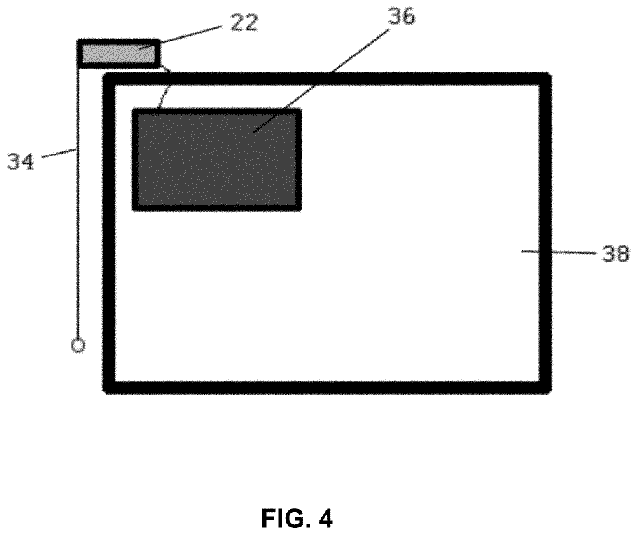

FIG. 4 illustrates a perspective view of a media player, in accordance with another embodiment of the present invention. More specifically, the use of media player 22 as Open/Closed signage media player in a business is illustrated in FIG. 4. A display monitor 36 facing street traffic, connected to media player 22, is placed at the shop window 38. With two memory media 20, 30 already inserted, one media stored with files for open business and the other media stored with files for closing, media player 22 is placed in an obscure and hard-to-reach location above the display monitor 36. Switching on power to both the media player 22 and the display monitor 36 starts displaying signage from files in one memory media immediately. Pulling cord 34 switches media player 22 to play files in the other memory media. This is as easy to use as that of the conventional Open/Closed signage.

In one embodiment, the memory media 20, 30 may be preloaded with files of common Open/Closed signs by manufacturer, thereby making the media player 22 a “Plug and Play” Open/Closed signage media player, in accordance with one exemplary embodiment. In accordance with one embodiment, the media player 22 may be provided with an auto-looping functionality for replaying files fed into the memory media, from beginning again after finished playing the last file.

In accordance with an embodiment of the present invention, to prevent theft, the media players 10, 22 may include a fixture that allows the media player to be bolted to a wall or any other support surface. In an embodiment, a cover plate or similar with locking device may be provided on the media player 10, 22 to protect memory media 20 and 30 from unauthorized removal.

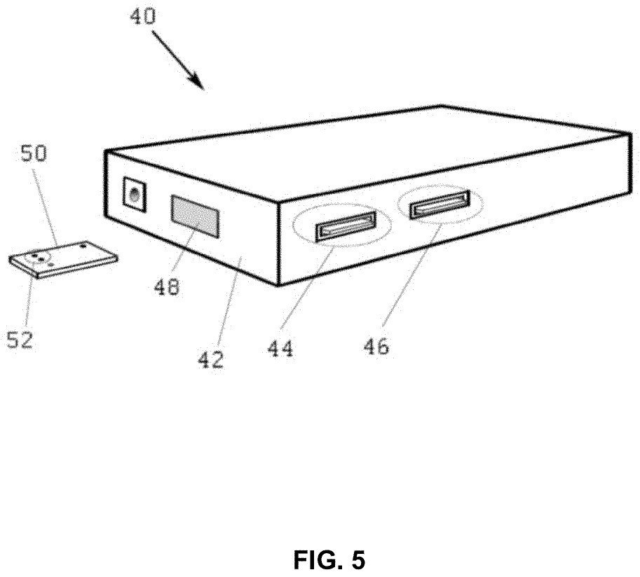

FIG. 5 illustrates a perspective view of a media player, in accordance with yet another embodiment of the present invention. In the embodiment illustrated in FIG. 5, the media player 40 includes a remote control to facilitate switching or activation of one of the dedicated memory sets 44, 46 for displaying the content stored therein. Remote control may be achieved by means of IR, RF, voice, gesture, etc. For illustrative purpose, IR remote control is used. More specifically, in the present embodiment, the two dedicated memory sets 44 and 46, each include their own remotely switchable ON/OFF switching mechanism built into the circuitry of the media player unit 42. In one embodiment, an IR receiver 48 may be built into media player unit 42 for communicating with a hand-held IR transmitter 50. One or more buttons 52 on the IR transmitter 50 may facilitate selection of the dedicated memory set to be activated for playing and displaying the files stored therein.

In one embodiment, besides the regular Open/Closed files stored in any of the two dedicated memory sets, a user may have files for special events or announcements to display. The user may add these special event files to one of the memory media from any of the dedicated memory sets, or just use a new memory media to store these special event files and plug into a memory media slot when needed. The obvious advantage is new files can be prepared in advance by the user or by a third party in a system unrelated to this invention. However, a disadvantageous aspect of such an arrangement is that one of the memory media needs to be removed from the memory media slot, either to be fed with the required files, or allow a new memory media to be inserted to the memory media slot. Furthermore, after the special event is over, the memory media again needs to be removed from the memory media slot to delete the files associated with the special event.

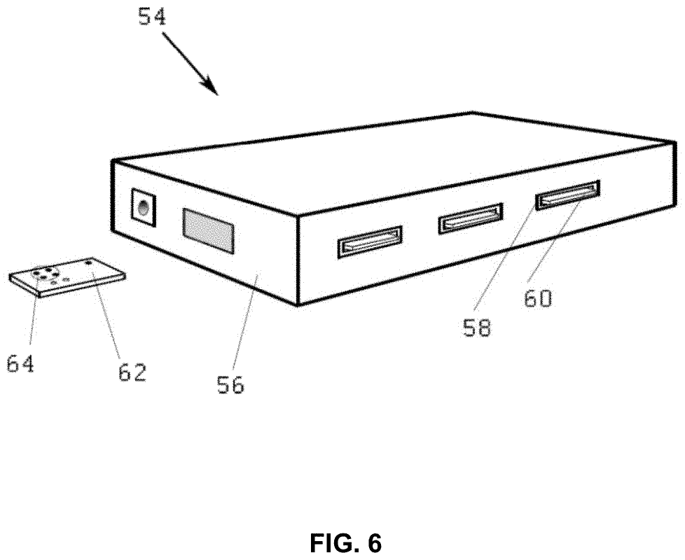

FIG. 6 illustrates a perspective view of a media player, in accordance with yet another embodiment of the present invention. The media player 54 comprises an additional memory media slot 58. It is to be noted that media player 54 may include any number of memory media slots, per the end application requirements. In accordance with one embodiment, the files associated with the special events may be stored in a third memory media 60 inserted into the third memory media slot 58 of a media player unit 56. In one embodiment, a hand-held transmitter 62 may have a set of buttons 64 may be used to control which set of files are played on the media player 54. In another embodiment, a single or double-pole-multiple-throw switch with pull cord may be used to control which set of files are played via the media player.

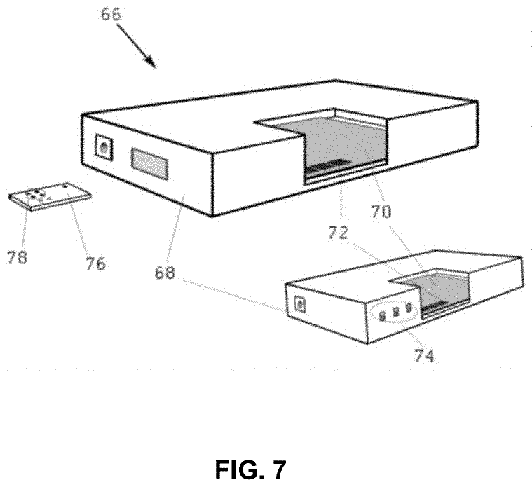

FIG. 7 illustrates a perspective view of a media player, in accordance with yet another embodiment of the present invention. In accordance with one embodiment, the media player 66 comprises dedicated sets of memories 72, which may be non-volatile memories such as FLASH. The circuitry of the dedicated sets of memories may be built directly into a circuit board 70 of a media player unit 68. In one embodiment, the number of sets of dedicated memories may be two or more, in accordance with end application requirements. In yet another embodiment, the media player 66 may include only one set of dedicated memory, which provides a cost effective option for businesses to display only files for open hours. In one embodiment, an ON/OFF switching mechanism for each set of dedicated memory may either be built into the circuit board 70 or may remain as a physical ON/OFF switch 74 on the media player unit 68. In one embodiment, while the media player 66 is operational, the switching among the sets of dedicated memories may be controlled by either flipping the ON/OFF switches 74, or by pressing the dedicated buttons 78 on a hand-held IR transmitter 76.

In yet another embodiment, the ON/OFF switching of the dedicated memory sets may be facilitated via internet of things (IOT), wherein the media player may be controlled via an application installable on a smart device of the user.

In another embodiment, the media player may be configured to include an integral display.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied. Such computers referenced and/or described in this disclosure may be any kind of computer, either general purpose, or some specific purpose computer such as, but not limited to, a workstation, a mainframe, GPU, ASIC, etc. The programs may be written in C, or Java, Brew or any other suitable programming language. The programs may be resident on a storage medium, e.g., magnetic or optical, e.g., without limitation, the computer hard drive, a removable disk or media such as, without limitation, a memory stick or SD media, or other removable medium. The programs may also be run over a network, for example, with a server or other machine sending signals to the local machine, which allows the local machine to carry out the operations described herein.

Besides Open/Closed signage, this invention may be used where easy, un-scheduled, and instant switching of playing one set of media files to playing another set of media files is preferred. An example is displaying breakfast, lunch, or dinner special menu in a restaurant where the time to switch the menu is not fixed to the minute. Another example is displaying an “In case of emergency, please . . . ” sign on an office front-desk signage where the only receptionist has to attend a sudden un-scheduled event. Or switch on a welcoming message just minute before a VIP step into the reception area.

A tough problem with any system is security and privacy when outsider access is necessary. Since using this invention to display files does not require logging into the device or system where this invention is housed or connected, there is no related security or privacy issue at all. An example is letting outside vendors to display product demo video on a company signage connected with this invention. Another example is letting a service representative to show new information to a housewife on the screen of her smart refrigerator that has this invention built-in, even though her smart refrigerator is connected to her own network where personal information are stored.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing a media player according to the present invention will be apparent to those skilled in the art. Various aspects of the invention have been described above by way of illustration, and the specific embodiments disclosed are not intended to limit the invention to the particular forms disclosed. The particular implementation of the media player may vary depending upon the particular context or application. By way of example, and not limitation, the media player described in the foregoing were principally directed to display multimedia content such as videos implementations; however, similar techniques may instead be applied to display open/closed signage for a business establishment, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre AIA) or 35 USC 112(f) post-AIA. Otherwise, no limitations from the specification are to be read into any claims, unless those limitations are expressly included in the claims.

What is claimed is:

1. A media player unit having a circuitry, the media player unit comprising:
at least two dedicated memory sets, wherein one of said at least two dedicated memory set is fed with a first display content and another one of said at least two dedicated memory set is fed with a second display content; and
at least one switch coupled to each of said dedicated memory sets for facilitating selective playing of said first display content or said second display content stored in any one of said at least two dedicated memory sets by said media player unit.

2. The media player unit according to claim 1, wherein said first display content is Open signage for a business establishment, and said second display content is Closed signage for a business establishment.

3. The media player unit according to claim 1, wherein each said dedicated memory set comprises:
a memory media slot configured on a body of said media player unit; and
a memory media inserted within said memory media slot.

4. The media player unit according to claim 3, wherein said memory media is at least one a memory card or a USB stick.

5. The media player unit according to claim 1, wherein said at least one switch is configured on the body of said media player unit.

6. The media player unit according to claim 1, wherein each of said dedicated memory sets include a switch coupled thereto.

7. The media player unit according to claim 1, wherein said at least one switch is a single or double-pole-double-throw (SPDT or DPDT) toggle switch with a pull cord.

8. The media player unit according to claim 1, further comprising a display monitor for displaying content present in any one of the said dedicated memory sets.

9. The media player unit according to claim 1, further comprising a remote controller for facilitating the activation of said at least one switch.

10. A media player unit having a circuitry, said media player unit comprising:
a pair of dedicated memory sets, wherein one of said pair of dedicated memory sets is fed with a first display content and another one of said pair of dedicated memory sets is fed with a second display content; wherein each dedicated memory set comprises:
a memory media slot configured on a body of said media player unit; and
a memory media inserted within said memory media slot; and
a pair of switches coupled to each of said dedicated memory sets for facilitating selective playing of said first display content or said second display content stored in any one of said pair of dedicated memory sets by said media player unit.

11. The media player unit according to claim 10, wherein said first display content is Open signage for a business establishment, and said second display content is Closed signage for a business establishment.

12. The media player unit according to claim 10, wherein said memory media is at least one a memory card or a USB stick.

13. The media player unit according to claim 10, further comprising a display monitor for displaying content present in any one of the said dedicated memory sets.

14. The media player unit according to claim 10, further comprising a remote controller for facilitating the activation of said pair of switches.

15. A media player unit having a circuitry, said media player unit comprising:
a plurality of dedicated memory sets, wherein each dedicated memory set comprises:
a memory media slot configured on a body of said media player unit; and
a memory media inserted within said memory media slot; and
at least one switch coupled to each of said dedicated memory sets for facilitating selective playing of content stored in any one of said plurality of dedicated memory sets by said media player unit.

16. The media player unit according to claim 15, wherein said memory media is at least one a memory card or a USB stick.

17. The media player unit according to claim 15, further comprising a display monitor for displaying content present in any one of the said dedicated memory sets.

18. The media player unit according to claim 15, further comprising a remote controller for facilitating the activation of said at least one switch.

19. A media player unit having a circuitry, said media player unit comprising:
a plurality of dedicated memory sets, wherein each dedicated memory set is built in on said circuitry; and
at least one switch coupled to each of said dedicated memory sets for facilitating selective playing of content stored in any one of said plurality of dedicated memory sets by said media player unit.

20. The media player unit according to claim 19, further comprising a remote controller for facilitating the activation of said at least one switch.

21. The media player unit according to claim 19, further comprising a display monitor for displaying content present in any one of the said dedicated memory sets.

22. The media player unit according to claim 1, wherein the said dedicated memory sets are housed in a separate enclosure in wired connection to the said media player.

23. The media player unit according to claim 10, wherein the said dedicated memory sets are housed in a separate enclosure in wired connection to the said media player.

24. The media player unit according to claim 15, wherein the said dedicated memory sets are housed in a separate enclosure in wired connection to the said media player.
